(19) United States
(12) Patent Application Publication
(10) Pub. No.: US 2026/0127588 A1
(43) Pub. Date: May 7, 2026

(54) BEISIGN: Policy-Controlled Digital Transactions with Minimum-Disclosure Attestation, Dual-Window Rollback, ISO 20022 Extensions, and Clearing/Treasury Settlement

(71) Applicant: FURONG BEI, SAN GABRIEL, CA (US)

(72) Inventor: FURONG BEI, SAN GABRIEL, CA (US)

(21) Appl. No.: 19/357,257

(22) Filed: Oct. 14, 2025

Related U.S. Application Data
(63) Continuation-in-part of application No. 19/315,561, filed on Aug. 31, 2025.
(63) Continuation-in-part of application No. 19/067,907, filed on Mar. 2, 2025.
(63) Continuation-in-part of application No. 19/067,845, filed on Mar. 1, 2025.
(63) Continuation-in-part of application No. 19/192,322, filed on Apr. 28, 2025.
(63) Continuation-in-part of application No. 19/056,745, filed on Feb. 19, 2025.
(63) Continuation-in-part of application No. 19/078,276, filed on Mar. 13, 2025.
(63) Continuation-in-part of application No. 19/067,732, filed on Feb. 28, 2025.
(63) Continuation-in-part of application No. 19/094,730, filed on Mar. 28, 2025.
(63) Continuation-in-part of application No. 19/072,412, filed on Mar. 6, 2025.
(63) Continuation-in-part of application No. 19/196,039, filed on May 1, 2025.
(63) Continuation-in-part of application No. 19/074,352, filed on Mar. 8, 2025.
(63) Continuation-in-part of application No. 19/097,892, filed on Apr. 2, 2025.
(60) Provisional application No. 63/769,143, filed on Mar. 9, 2025.
(60) Provisional application No. 63/772,633, filed on Mar. 16, 2025.

(51) Int. Cl. G06Q 20/38

(52) U.S. Cl. CPC G06Q 20/3827

(57) ABSTRACT

A policy-controlled transaction system implements an A⋅C⋅T pipeline (Attest-Consent-Transact) with minimum-disclosure attestation and device-side BEITAPE capture. A policy engine retrieves a versioned policy (BEISEC) and reason codes. A dual-window rollback state machine provides Δt1 user rollback and Δt2 compliance rollback before finalization. A clearing ticket (BEICT) embeds an audit_hash computed over BEITAPE, a secure execution token (BEISET), and the policy_version, which are carried end-to-end in ISO 20022 messages. Upon expiry of Δt1/Δt2 without valid rollback, the BEICT is finalized through BEICX and a BillProof is written to BEITREASURY; an external validator can recompute audit_hash and issue a signed verification report. The approach reduces data exposure while enabling verifiable compliance, reversible execution, and auditable settlement.

### CROSS-REFERENCE TO RELATED APPLICATIONS

This application is a Continuation-in-Part (CIP) of U.S. patent application Ser. No. 19/196,039, filed May 1, 2025, entitled “Dynamic BEI Signature (BEISIGN) System for Global 8.2 Billion Users Covering 999 Demands, 365 Industries, All Currencies and Resources Across 1,600 Infinite Ecosystems . . . ”. The entire contents of the foregoing application are incorporated by reference to the extent permitted by law.

### INCORPORATION BY REFERENCE

The disclosure of U.S. patent application Ser. No. 19/196,039 (and any U.S. patent application publication thereof) is incorporated by reference in its entirety, including overlapping definitions and embodiments, consistent with 37 C.F.R. § 1.57.

### FIELD OF THE INVENTION

The disclosure relates to policy-controlled digital transactions implementing minimum-disclosure attestation, a dual-window rollback state machine (Δt1 user rollback; Δt2 compliance rollback), ISO 20022 message extensions carrying policy_version and audit_hash, clearing tickets (BEICT), clearing services (BEICX), and treasury settlement (BEITREASURY), collectively enabling a Behavioral-Economics-Identity (BEI) transaction fabric.

### BACKGROUND

Conventional switch-code and card-network rails often bind identity, consent, and settlement into a single irreversible step, expose excessive personal data, provide limited rollback semantics, and lack any independent audit anchor verifiable by third parties. There is a need for a system that attests with minimum disclosure, binds consent to a versioned policy, executes with freeze-then-finalize, provides two independent rollback windows (Δt1 for user reversal; Δt2 for compliance hold/reversal), and persists audit-verifiable traces across clearing and treasury.

### SUMMARY

Disclosed is an executable A⋅C⋅T pipeline (Attest→Consent→Transact) via a BEIACT gateway; a verifiable dual-window rollback state machine over BEICT tickets with Δt1 and Δt2 triggers; ISO 20022 extensions carrying policy_version and audit_hash end-to-end; a policy version registry (BEISEC) with reason codes and a local policy cache; minimum-disclosure attestation via TagProof and BEITAPE capture (e.g., NFC nonce, BLE distance-bounding, time-of-flight); clearing/treasury closure using BEICX and BEITREASURY BillProof; and an external validator recomputing audit_hash and issuing signed verification reports. Implementations are suitable for FRAND/SEP contribution without limiting scope.

### BRIEF DESCRIPTION OF THE DRAWINGS

FIG. 1 is a BEISIGN architecture overview.

FIG. 2 is a dual-window rollback state machine and message sequence.

FIG. 3 shows data structures (BEITAPE/BEISET/BEICT) and ISO 20022 mapping including policy_version and audit_hash.

FIG. 4 shows BEIACT modules and interfaces.

FIG. 5 shows an A⋅C⋅T sequence with Δt1/Δt2 and finalization (BillProof).

### DEFINITIONS

TagProof: a minimum-disclosure cryptographic proof or selective-disclosure credential proving facts without revealing raw personal data.
BEITAPE: a device-side evidence record (e.g., NFC nonce, BLE distance-bounding, time-of-flight samples, witness weighting) cryptographically bound to the transaction.
BEISET: a secure execution token containing policy-gated execution limits and a revocation_hook.
BEICT: a clearing ticket encoding state (frozen, rollback, final), audit_hash, and reason codes.
BEISEC: a policy version registry providing policy_version and jurisdictional reason codes.
BEICX: a clearing service; BEITREASURY: a treasury sink writing BillProof.
External Validator: a verifier that recomputes audit_hash and issues a signed verification report.

### DETAILED DESCRIPTION

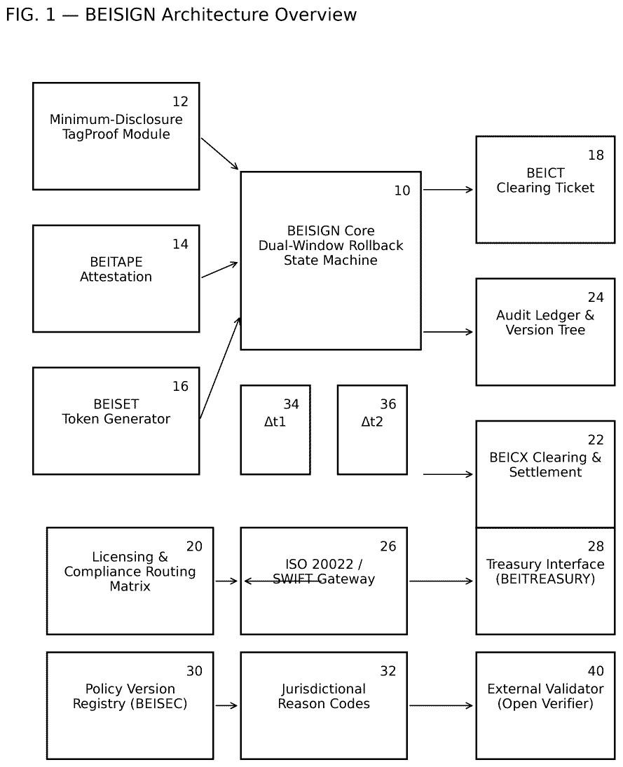

System Architecture (FIG. 1). A BEISIGN core orchestrates the A⋅C⋅T pipeline. The minimum-disclosure module generates TagProof from device/context evidence. BEITAPE binds evidence samples to identity/session. The policy engine queries BEISEC for a policy_version and reason codes; a local policy cache may store active versions. The state machine enforces Δt1 (user) and Δt2 (compliance) windows. The ticket generator issues BEICT embedding an audit_hash over at least BEITAPE, BEISET, and policy_version. A BEICX interface finalizes; BEITREASURY persists BillProof for settlement. An audit ledger with a version tree records state transitions; an external validator can recompute audit_hash.

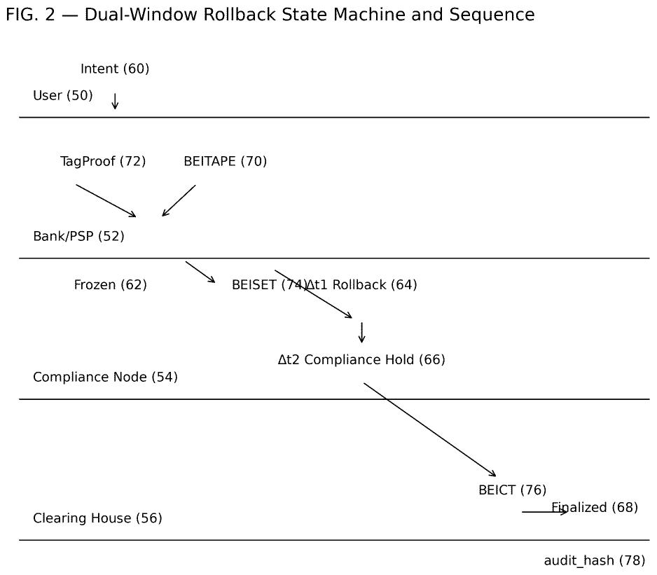

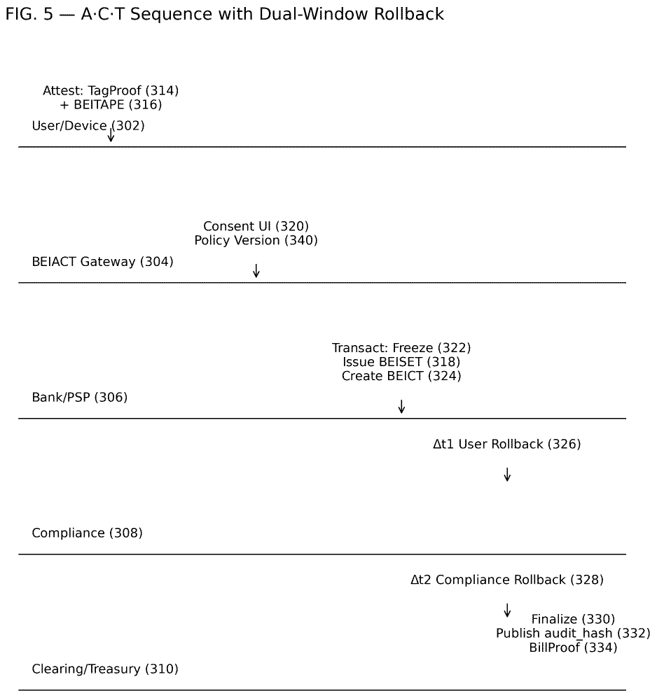

Dual-Window State Machine & Sequence (FIGS. 2 and 5). Attest: passkeys/DID login; TagProof+BEITAPE capture. Consent: user consent explicitly bound to policy_version (BEISEC). Transact: issue BEISET; freeze rights/consideration; generate BEICT with audit_hash. Rollback windows: Δt1 enables user-initiated reversal for mis-taps or fraud; Δt2 enables compliance hold/reversal using reason codes. If neither window triggers, the system finalizes and posts to BEICX/BEITREASURY.

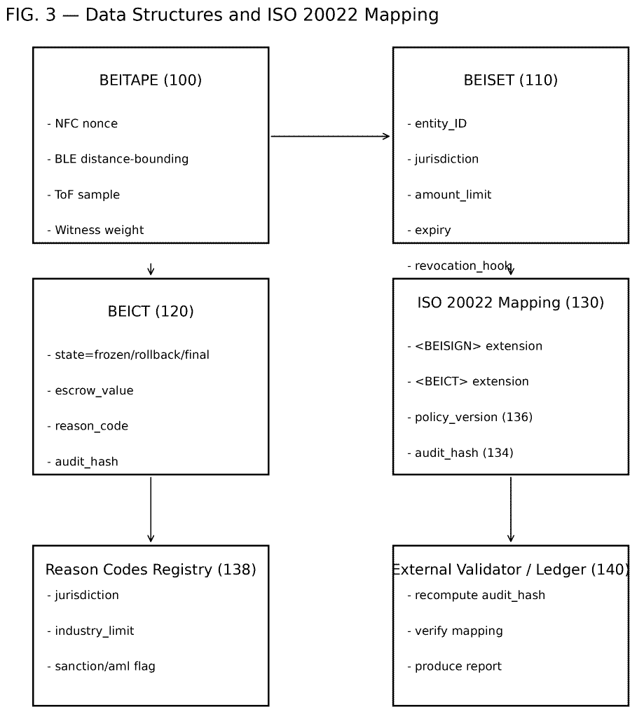

Data Structures & ISO 20022 Mapping (FIG. 3). BEITAPE evidence fields may include NFC nonces, BLE distance-bounding, and time-of-flight; BEISET fields include entity_ID, jurisdiction, amount_limit, expiry, and a revocation_hook; BEICT includes state, escrow_value, reason_code, and audit_hash. ISO 20022 extension elements carry policy_version and audit_hash; raw evidence is not in-band.

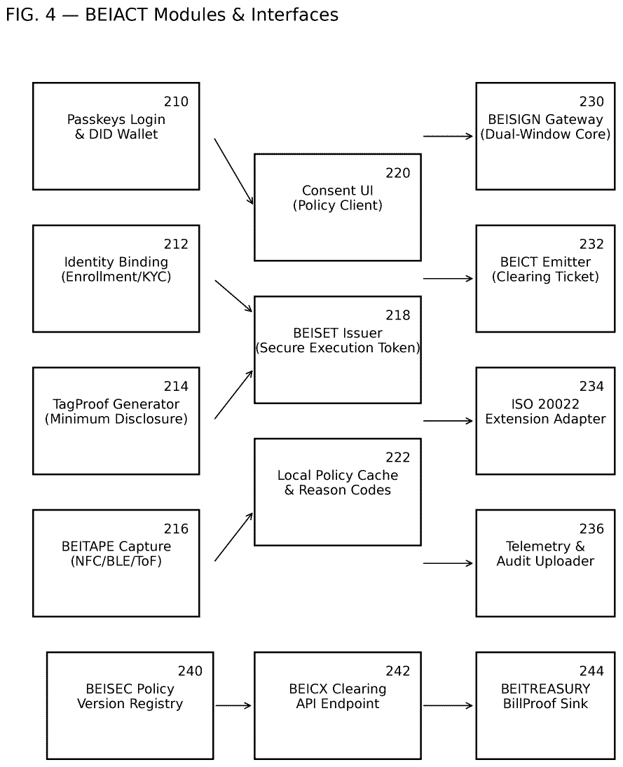

BEIACT Modules & Interfaces (FIG. 4). Passkeys login and DID wallet bind identity. A consent UI binds user consent to policy_version. A BEISET issuer mints a token gating execution; a local policy cache supports offline/low-latency checks. A BEISIGN gateway and BEICT emitter bridge to BEICX; telemetry/audit uploader logs transitions to an audit ledger.

### Technical Effects

Implementations disclosed herein are executed as finite state machines at gateway, client, and clearing nodes (see FIGS. 2 and 5), not as mere business rules. The dual-window rollback semantics (Δt1 user rollback; Δt2 compliance rollback) are enforced by code paths that gate BEISET issuance, freeze/hold, revocation, and finalization of BEICT tickets.

Measured technical effects include: (i) error-execution reduction via a bounded-latency Δt1 reversal path; (ii) an auditable approval chain with end-to-end persistence of policy_version and reason_code and an audit_hash computed over the BEITAPE/BEISET/BEICT tuple; and (iii) deterministic third-party recomputation wherein an external validator recomputes audit_hash from message payloads and confirms integrity without access to private operator logs.

Representative non-limiting targets: Δt1 rollback latency≤X seconds (P95); Δt2 hold propagation≤Y seconds (P95); audit-hash recomputation success=100% on compliant payloads.

### Security & Privacy Considerations

TagProof enables zero-knowledge or selective disclosure. The revocation_hook automatically cancels BEISET on Δt1/Δt2. Only audit_hash and identifiers traverse standard messages; raw evidence remains controlled. Policy caching is versioned; expired policies trigger re-consent or denial.

### Alternatives and Extensions

Cross-rail or cross-ledger mappings can preserve policy_version and audit_hash. SDKs and gateways (BEISDK/BEIKITS) implement client-side enrollment, consent UI, and policy caching. External validators may be operated by regulators or neutral utilities.

1. A transaction control system comprising: a BEISIGN core configured to orchestrate an A⋅C⋅T pipeline comprising an attestation stage, a consent stage, and a transact stage; a minimum-disclosure attestation module operative to generate a TagProof and to produce a BEITAPE record; a policy engine accessing a policy version registry (BEISEC) that supplies a policy_version and reason codes; a state machine implementing dual rollback windows comprising a Δt1 user rollback window and a Δt2 compliance rollback window; a ticket generator to issue a clearing ticket (BEICT) that embeds an audit_hash computed over at least the BEITAPE, a secure execution token (BEISET), and the policy_version; and an interface to a clearing service (BEICX) to finalize the BEICT upon satisfaction of policy during the Δt1 and Δt2 windows, wherein the system carries the policy_version and the audit_hash end-to-end inside a financial message conforming to ISO 20022.

2. The system of claim 1, wherein the TagProof comprises a zero-knowledge proof or a selective-disclosure credential.

3. The system of claim 1, wherein the BEITAPE includes one or more of NFC nonces, BLE distance-bounding samples, time-of-flight measurements, and witness-weighting data captured at a point of interaction.

4. The system of claim 1, wherein the BEISET contains fields comprising entity_ID, jurisdiction, amount_limit, expiry, and a revocation_hook that is triggered on Δt1 or Δt2 events.

5. The system of claim 1, wherein the policy engine enforces the reason codes supplied by the BEISEC registry and logs the reason codes into the BEICT.

6. The system of claim 1, further comprising a local policy cache on a client or gateway to hold an active policy_version for offline or low-latency checks.

7. The system of claim 1, further comprising an audit ledger with a version tree storing audit_hash values for each state transition of the BEICT.

8. The system of claim 1, further comprising an external validator configured to recompute the audit_hash from a message payload and to produce a signed verification report.

9. The system of claim 1, wherein finalization causes a BillProof to be written to a treasury sink (BEITREASURY) for settlement and revenue sharing.

10. A method for policy-controlled transactions comprising: receiving an attestation including a TagProof and a BEITAPE; obtaining consent bound to a policy_version from BEISEC; upon transact issuing a BEISET and freezing funds or rights and generating a BEICT embedding an audit_hash and the policy_version; maintaining a Δt1 user rollback window and upon a trigger revoking the BEISET and reverting the BEICT to a pre-final state; maintaining a Δt2 compliance rollback window during which a compliance node can place a compliance hold with a reason code; and upon expiry of the Δt1 and the Δt2 windows without valid rollback finalizing the BEICT and forwarding the BEICT to clearing.

11. The method of claim 10, further comprising inserting the policy_version and the audit_hash as ISO 20022 extension elements in a financial message exchanged between participants.

12. The method of claim 10, wherein finalization comprises posting the BEICT to BEICX and recording a BillProof with BEITREASURY.

13. The method of claim 10, wherein multiple jurisdictions are evaluated and a dominant policy is selected based on counterparties'jurisdictions and transaction type.

14. The method of claim 10, further comprising uploading telemetry and audit data of state transitions and reason codes to an audit ledger.

15. The method of claim 10, wherein the TagProof is verified without revealing underlying personal data and the BEITAPE is cryptographically bound to the BEISET and the BEICT.

16. A non-transitory computer-readable medium storing instructions that when executed cause one or more processors to perform the operations of claim 10.

17. The medium of claim 16, wherein the operations further include passkeys-based login and decentralized-identifier wallet binding prior to the attestation stage.

18. The medium of claim 16, wherein the operations further include executing a revocation_hook that automatically cancels the BEISET when a Δt1 or a Δt2 rollback is confirmed.

19. The medium of claim 16, wherein the operations further include publishing the audit_hash to an external validator application programming interface and storing the validator's signed report with the BEICT.

20. The medium of claim 16, wherein the operations further include cross-ledger or cross-rail mapping of the BEICT to a settlement network while preserving the policy_version and the audit_hash fields.
